(19) United States
(12) Patent Application Publication
(10) Pub. No.: US 2006/0228141 A1
(43) Pub. Date: Oct. 12, 2006

(54) Tape processing apparatus, method of controlling tape feed in tape processing apparatus, and program

(75) Inventor: Makoto Takada, Shiojiri-shi (JP)

Correspondence Address: HOGAN & HARTSON L.L.P., 500 S. GRAND AVENUE, SUITE 1900, LOS ANGELES, CA, 90071-2611, US

(73) Assignee: SEIKO EPSON CORPORATION

(21) Appl. No.: 11/400,081

(22) Filed: Apr. 6, 2006

(30) Foreign Application Priority Data
Apr. 7, 2005 (JP) 2005-111422

(51) Int. Cl. B41J 3/32; B41J 29/38

(52) U.S. Cl. 400/76; 400/109.1

(57) ABSTRACT

A tape processing apparatus includes: a feeding device for feeding a processing tape along a tape feed passage; an ink-character printing device for printing ink characters and a Braille-emboss device for embossing Braille characters, respectively on the processing tape to be fed by the feeding device; a mode selecting device for selecting one of an ink-character print processing, a Braille-emboss processing, and a complex processing of ink-character printing and Braille embossing; and a feed control device for controlling the feeding device. The feed control device controls, in the Braille-emboss processing, such that the tape feed speed when a Braille-emboss region of the processing tape passes through the ink-character printing device is higher than a tape feed speed at a time of printing.

The entire disclosure of Japanese Patent Application No. 2005-111422, filed Apr. 7, 2005, is expressly incorporated by reference herein.

### BACKGROUND

1. Technical Field

The present invention relates to a tape processing apparatus in which ink-character printing and Braille embossing are performed on a processing tape while the tape is being fed, and to a method of controlling the tape feed in the tape processing apparatus, as well as to a program.

2. Related Art

There is known a Braille label having disposed on the same tape Braille characters that can be recognized by a visually impaired person and ink characters (characters printed with ink) that can be recognized by a sighted person so that the Braille label can be recognized by both the visually impaired person and the sighted person.

As an apparatus for forming or producing this kind of Braille tape, there is known one having an ink-character printing section for performing ink-character printing and a Braille-emboss section for performing Braille embossing to thereby perform both ink-character printing and Braille embossing in a series of tape feed operations. Japanese Utility Model No. 3054580 is an example of related art.

In this kind of tape processing apparatus, the ink-printing mechanism and the Braille-emboss mechanism are independent of each other. Therefore, there can be performed processing of the ink-character printing, processing of Braille embossing, and both the processes of ink-character printing and Braille embossing.

However, when only the Braille embossing is performed, it is estimated that the tape feeding is performed to suit the printing speed at the time of performing the printing of the ink-characters. Therefore, as compared with a total time required for tape processing with Braille embossing and also with ink-character printing, the total time required for tape processing with Braille embossing but without ink-character printing becomes the same with the total time required in the case of performing both the Braille embossing and ink-character printing. There is thus a problem in that the time efficiency becomes poor.

The invention has an advantage of providing: a tape processing apparatus in which the time efficiency with Braille-emboss processing can be improved; a feed control method of a tape processing apparatus; and a program.

According to one aspect of the invention, there is provided a tape processing apparatus comprising: a feeding device for feeding a processing tape along a tape feed passage; an ink-character printing device for printing ink characters and a Braille-emboss device for embossing Braille characters, respectively on the processing tape to be fed by the feeding device; a mode selecting device for selecting one of an ink-character print processing, a Braille-emboss processing, and a complex processing of ink-character printing and Braille embossing; and a feed control device for controlling the feeding device, wherein the feed control device controls, in the Braille-emboss processing, such that the tape feed speed when a Braille-emboss region of the processing tape passes through the ink-character printing device is higher than a tape feed speed at a time of printing.

It is another advantage of the invention to provide a feed control method of a tape processing apparatus. The apparatus comprises a feeding device for feeding a processing tape along a tape feed passage, and an ink-character printing device for printing ink characters and a Braille-emboss device for embossing Braille characters, respectively on the processing tape to be fed by the feeding device, the apparatus selectively performing one of an ink-character print processing, a Braille-emboss processing and a complex processing of ink-character printing and Braille embossing. The method comprises controlling, in the Braille-emboss processing, such that the tape feed speed when a Braille-emboss region of the processing tape passes through the ink-character printing device is higher than a tape feed speed at a time of printing.

In the Braille-emboss processing, even when the Braille-emboss region of the processing tape reaches the ink-character printing device, there is performed no ink-character print processing. According to this configuration, in the Braille-emboss processing, the tape feed speed when the Braille-emboss region of the processing tape passes through the ink-character print region is controlled to become higher than the tape feed speed at the time of printing the ink characters. Therefore, the time for the Braille-emboss region to pass through the ink character printing device can be shortened. As a result, the total time required for the Braille-emboss processing inclusive of the tape feed can be shortened.

In the tape processing apparatus, it is preferable that: in the Braille-emboss processing, an information-print region for printing therein indicating information which indicates a manual insertion direction is set on an outside of a Braille-emboss region; the processing tape is manually inserted into the Braille-emboss device after having printed the indicating information by the ink-character printing device; and the feed control device controls, in the Braille-emboss processing, such that the tape feed speed when the information-print region passes through the ink-character printing device is equal to the tape feed speed at the time of printing.

In the feed control method of the tape processing apparatus, it is preferable that, in the Braille-emboss processing, an information-print region for printing therein indicating information which indicates a manual insertion direction is set on an outside of a Braille-emboss region, that the processing tape is manually inserted into the Braille-emboss device after having printed the indicating information by the ink-character printing device, and that the feed control device controls, in the Braille-emboss processing, such that the tape feed speed when the information-print region passes through the ink-character printing device is equal to the tape feed speed at the time of printing.

According to the above configuration, in the print processing which is associated with the Braille-emboss processing, the tape feed speed when the information-print region passes through the ink-character printing device can be appropriately maintained.

According to yet another aspect of the invention, there is provided a program for causing a computer to operate each of the devices in the above-referenced tape processing apparatus.

According to this configuration, there is made available a program which is capable of improving the time efficiency of tape processing.

### BRIEF DESCRIPTION OF THE DRAWINGS

The invention will be described with reference to the accompanying drawings, wherein like numbers reference like elements.

FIG. 1 is an outside perspective view of a label forming apparatus with a cover kept closed.

FIG. 2 is an outside perspective view of the label forming apparatus with the cover left open.

FIGS. 3A and 3B are schematic plan view and sectional view, respectively, of a Braille-emboss unit.

FIG. 4 is a schematic plan view explaining the traveling of a processing tape in a Braille-emboss unit.

FIG. 5 is a control block diagram of the label forming apparatus.

FIGS. 6A and 6B are schematic plan views explaining the tape insertion into the Braille-emboss section.

FIGS. 7A to 7C are schematic views explaining each of the processing modes.

FIG. 8 is a flow chart showing an overall processing of the label forming apparatus.

FIG. 9 is a flow chart showing a subroutine of FIG. 8.

FIG. 10 is a flow chart showing another subroutine of FIG. 8.

FIGS. 11A and 11B are schematic plan view and diagram, respectively, showing the tape feed speed in the first processing mode (complex processing of ink-character printing and Braille embossing).

FIGS. 12A and 12B are schematic plan view and diagram, respectively, showing the tape feed speed in the third processing mode (only Braille embossing) in which the Braille format is Braille-upper.

FIGS. 13A and 13B are schematic plan view and diagram, respectively, showing the tape feed speed in the third processing mode (only Braille embossing) in which the Braille format is Braille-lower.

### DESCRIPTION OF EXEMPLARY EMBODIMENTS

With reference to the accompanying drawings, a description will now be made about an example in which a sheet processing apparatus of an embodiment of the invention is applied to a label forming apparatus. This label forming apparatus has an ink-character printing section and a Braille-emboss section. In the ink-character printing section, ink characters are printed on a processing tape and the printed portion of the tape is cut to thereby obtain a tape piece (a piece of tape). The tape piece thus obtained is manually inserted into the Braille-emboss section to thereby perform therein Braille embossing on the tape piece.

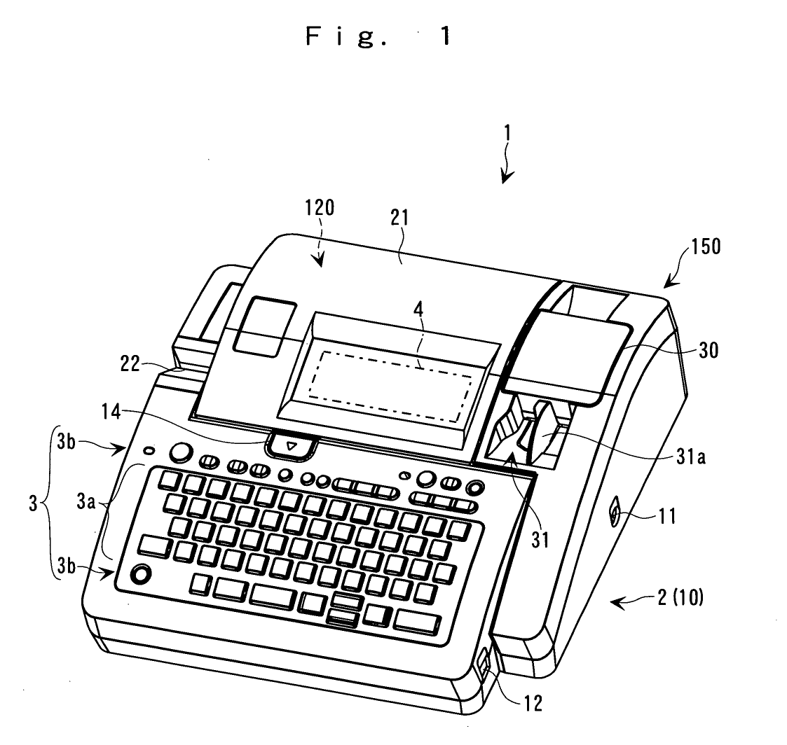

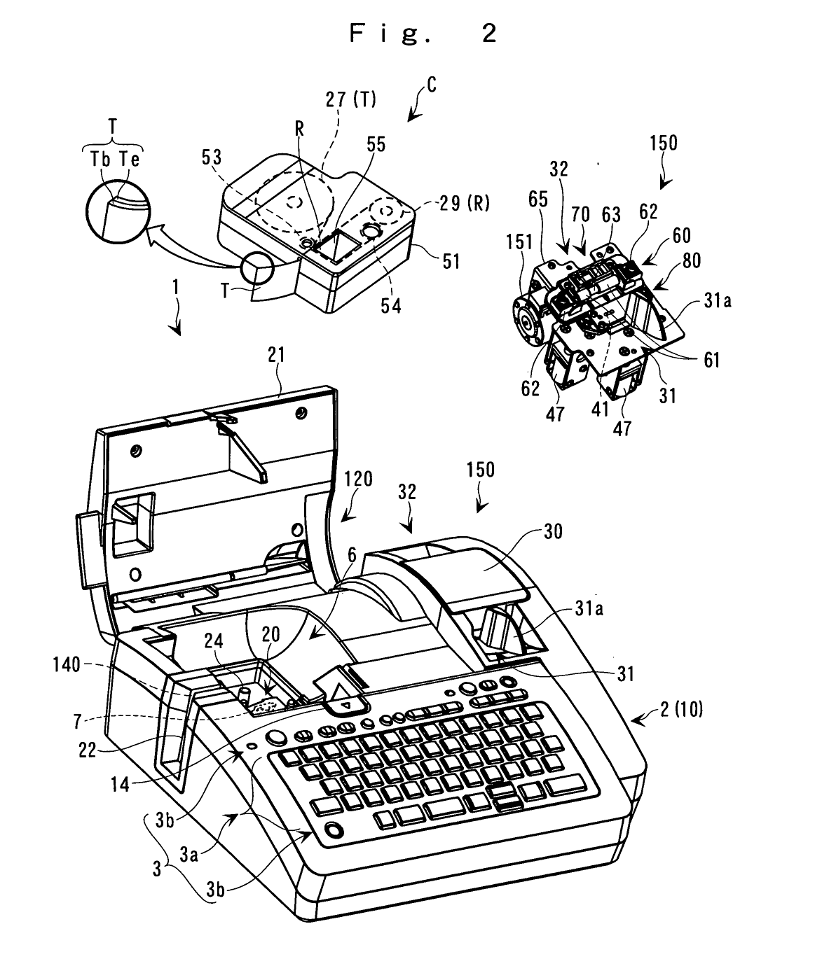

FIG. 1 is an outside perspective view of the label forming apparatus with its lid kept closed. FIG. 2 is an outside perspective view thereof with the lid left open. As shown in FIGS. 1 and 2, the label forming apparatus 1 is provided with: an apparatus main body 10 in which ink-character printing is performed on the processing tape T and in which Braille embossing is performed on the processing tape T that is obtained from an ink-character printing section; and a tape cartridge C which houses therein the processing tape T and an ink ribbon R and which is detachably mounted on the apparatus main body 10.

The apparatus main body 10 has: an outer frame made of an apparatus casing 2; the ink-character printing section 120 which is arranged in a manner to be widely disposed therein; and the Braille-emboss section 150 disposed in a rear of the right-half portion of the apparatus casing 2. The terms “rear,”“front,”“right,”and “left” are used in this specification as seen in FIGS. 1 and 2 from the operator of the apparatus. On an upper surface of the front-half portion of the apparatus casing 2, there is disposed a keyboard 3 which is provided with a character key group 3a and a function key group 3b for designating various operation modes, or the like. On an upper surface of a rear-half portion of the apparatus casing 2, there is provided an open/close lid 21 so as to cover a substantial portion thereof. A lid-operating button 14 for opening the lid 21 is provided to the front side of the open/close lid 21. A rectangular display 4 for displaying the result of inputting, or the like through the keyboard 3 is provided on an upper surface of the open/close lid 21.

Inside the open/close lid 21 which can be left open by depressing the lid-operating button 14, there is formed a cartridge mounting portion 6 in which is disposed a printing head 7 for performing ink-character printing on the processing tape T which is to be paid out (reeled out) of the tape cartridge C (see FIG. 2).

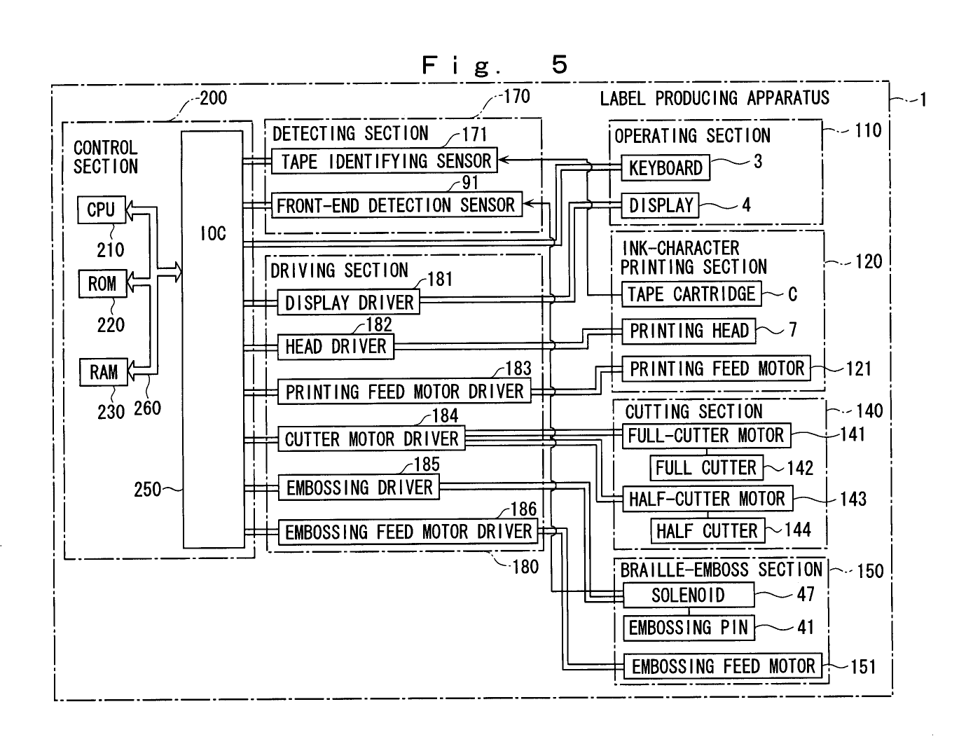

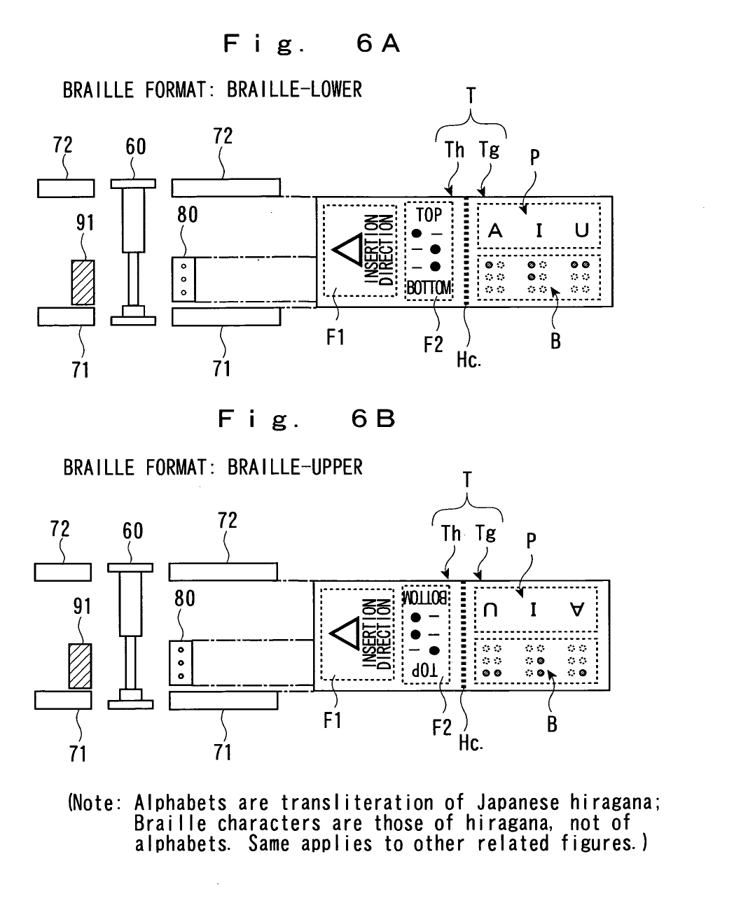

On a left side of the apparatus casing 2, there is formed a print-tape ejecting slot 22 which communicates the cartridge mounting portion 6 and the outside of the label forming apparatus 1. In a manner to face the print-tape ejecting slot 22, the apparatus casing 2 houses therein a cutting section 140 which cuts the processing tape T. The cutting section is disposed so as to lie close to the print-tape ejecting slot 22 and is provided with a full cutter 142 and a half cutter 144. The full cutter 142 is driven by a motor (full-cutter motor 141) to cut the processing tape T in a style of a pair of scissors. The half cutter 144 is disposed on a downstream side (as seen in the tape feed direction) relative to the full cutter 142 and is driven by a motor (half-cutter motor 143) to cut only a recording tape Tb which is described hereinafter, in a style of a pair of scissors (see FIG. 5). As a result of the half cutting, a half-cutting margin (indicator-information region) Th is formed at a front end portion of the processing tape T as seen in the direction of insertion thereof into the Braille-emboss section 150 (embossing assembly) (see FIG. 6B).

On the right side of the upper rear surface of the apparatus casing 2, there is disposed the Braille-emboss section 150. The Braille-emboss section 150 has formed therein: an embossing unit 80 which forms the main part of the Braille-emboss section 150; an embossing tape inserting slot 31 into which the processing tape T to be embossed with Braille is manually inserted from the leading (or front) edge thereof (as seen in the direction of feeding the tape) with the printing surface thereof facing upward; and an embossed tape ejecting slot 32 through which the processing tape T embossed with Braille is ejected rearward (i.e., away from the operator as seen in FIG. 2). The embossing tape inserting slot 31 is provided with a manual-insertion guide 31a whose width is adjustable. The Braille-emboss section 150 is provided on its upper part with an emboss-section cover 30 to cover the embossing unit 80.

On the right side of the apparatus casing 2, there are formed: a power supply port 11 for supplying the label forming apparatus 1 with electric power; and a connecting port 12 (interface) for connection to an outside apparatus such as a personal computer (not shown) The connecting port 12 thus allows for connection to an outside apparatus. In this configuration, it is so arranged that ink-character printing and Braille embossing can be performed based on character information or image information generated by the outside apparatus. Although omitted in FIGS. 1 and 2, the apparatus casing 2 has mounted therein a circuit board which constitutes a control section 200 (see FIG. 5) for performing an overall control of the apparatus main body 10.

The cartridge mounting portion 6 is made up of: the printing head 7 which has a thermal element and is covered with a head cover 20; a positioning boss 24 which aligns a tape reel 27 (which is described hereinafter); a platen drive shaft (not shown) which feeds the processing tape T and the ink ribbon R of the tape cartridge C and which lies opposite to the printing head 7; and a take-up drive shaft (not shown) which takes up the ink ribbon R. A tape identifying sensor 171 (see FIG. 5) which is made up of a plurality of microswitches is disposed in a corner portion of the cartridge mounting portion 6. On an inner portion of the bottom surface of the cartridge mounting portion 6, there are built in a printing feed motor 121 (see FIG. 5) for driving the platen drive shaft and the take-up drive shaft, a reduction gear train (not shown), or the like.

The tape cartridge C is constituted by housing inside a cartridge casing 51: a tape reel 27 around which is wound the processing tape T; a ribbon reel 29, at a right lower side thereof as seen from the operator, around which is wound the ink ribbon R; and a ribbon take-up reel 54. On a left lower side of the tape reel 27, there is formed a through opening 55 for insertion into the head cover 20 which covers the printing head 7. A platen roller 53 which comes into rotation fitting with the platen drive shaft is disposed to correspond to the portion in which the processing tape T and the ink ribbon R are overlapped with each other.

When the tape cartridge C is mounted into the cartridge mounting portion 6, the head cover 20 is inserted into the through opening 55, the positioning boss 24 is inserted into tape reel 27, the take-up drive shaft is inserted into the ribbon take-up reel 54, and the platen drive shaft is inserted into the platen roller 53. When the open/close lid 21 is closed in this state, in a manner interlocked with this closing operation, the printing head 7 comes into contact with the platen roller 53 with the processing tape T and the ink ribbon R sandwiched therebetween, thereby attaining a state of being ready for printing. Based on ink-printing data which is prepared by the control section 200 to comply with the character information inputted through the keyboard 3, or the like, the platen drive shaft and the take-up drive shaft make a periodic rotation. The ink-character printing is thus performed by the printing head 7 while feeding the processing tape T and the ink ribbon R. At the same time, the ink ribbon R paid out of the ribbon reel 29 is taken up by the ribbon take-up reel 54 by passing through the opening wall of the through opening 55. The processing tape T after having been subjected to the ink-character printing has formed therein a half-cut margin Th by the half cutter 144 (see FIG. 5) and the printed portion is cut by the full cutter 142 (see FIG. 5). The processing tape T thus cut is ejected out of the print-tape ejecting slot 22 to the outside of the apparatus.

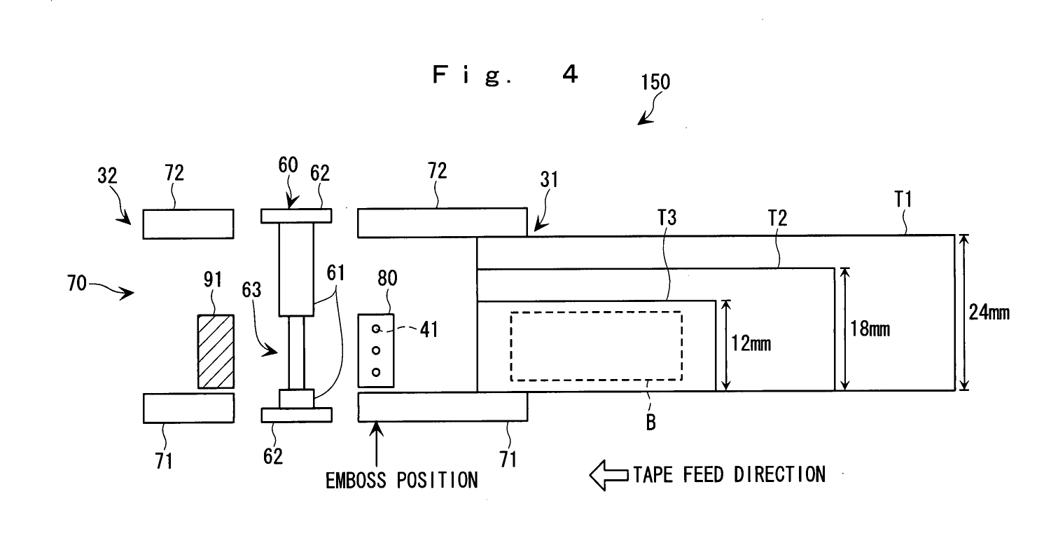

The processing tape T is constituted by a recording tape Tb which is made of polyethylene terephthalate (PET) and which has adhered an adhesive layer to a rear surface thereof, and a release (peel-off) tape Te which is made of PET and is adhered by this adhesive layer to the recording tape Tb. The processing tape T is housed inside the cartridge casing 51 in a state of being wound into a roll with the release tape Te lying on the inner side. As the processing tape T there are prepared three kinds, i.e., 12 mm, 18 mm and 24mm in tape width (see FIG. 4). On a rear side of the cartridge casing C, there are formed a plurality of small holes to be detected (not shown). These holes are identified by the tape identifying sensor 171 (see FIG. 5) to enable the kind of the processing tape T to be identified. The above-referenced processing tape T is for embossing Braille characters. For use only in printing ink characters, there is also prepared a printing tape whose release tape Te is made of high-quality paper. In other words, there are prepared a Braille-emboss cartridge containing therein a processing tape for Braille-emboss purpose and an ink-character printing cartridge containing therein a processing tape for printing purpose. These cartridges C have the same shape as seen in plan view and, therefore, a cartridge C suitable for the intended use can be mounted on the cartridge mounting portion 6.

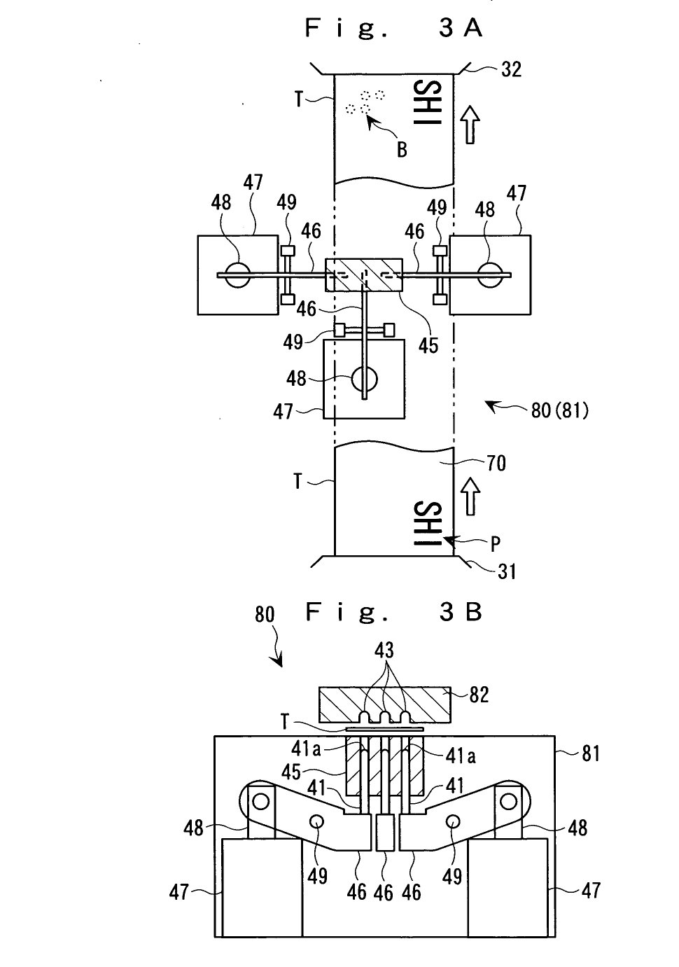

With reference to FIGS. 3A and 3B, a description will now be made about the detailed construction of an embossing unit 80. FIG. 3A is a plan view of the embossing unit 80 when viewed from the top and FIG. 3B is a sectional view thereof. The embossing unit 80 is made up of: an embossing portion 81 which is disposed on an upstream side of the feed roller 61 as seen in the tape feed direction and is disposed below the inserted processing tape T; and an emboss receiving portion 82 which is disposed in a position opposite to the embossing portion 81. The embossing portion 81 includes: three embossing pins 41 which are arrayed to correspond to the vertical three emboss salients out of six emboss salients which constitute a Braille character (six-point Braille); an emboss pin guide 45 which guides the emboss movements of the three embossing pins 41 in a manner to be projected and retracted; and three solenoids 47 which serve as the driving source.

The emboss receiving portion 82 has formed therein three receiving grooves 43 which correspond to the three embossing pins 41. While feeding the processing tape T by means of a tape feed unit 60, the three embossing pins 41 are selectively jumped up (or lifted) toward the receiving grooves 43 with the three solenoids 47 serving as the driving source. In this manner, emboss operation is performed on the processing tape T to thereby form so-called six-point embossing salients. The head portion 41a of each embossing pin 41 is formed into a rounded cylindrical shape so that the embossed salient of the processing tape becomes a rounded cylinder in shape. The rear end portion of each embossing pin 41 is connected to one end of an arm member 46 in a semi-fixed manner. To the other end of this arm member 46 is pivotally connected a front end portion of a plunger 48 of the solenoid 47. A supporting member 49 is provided so as to pivotally support an intermediate portion of the arm member 46.

With reference to FIG. 4, a description will now be made about the feeding operation of the processing tape T at the Braille-emboss section 150. The Braille-emboss section 150 faces the tape traveling passage 70 which linearly connects the embossing tape inserting slot 31 and the embossed tape ejecting slot 32. The Braille-emboss section 150 is made up of: the embossing unit 80 (a Braille-emboss device) which performs embossing of Braille characters and is disposed on the half side of the cartridge mounting portion 6 as seen in the widthwise direction of the tape traveling passage 70; the tape feed unit 60 which feeds the processing tape T manually inserted from the embossing tape inserting slot 31 toward the embossed tape ejecting slot 32; and guide members. 71, 72 which guide the transporting of the processing tape T along the tape traveling passage 70. The embossing tape inserting slot 31 is arrange to be capable of inserting thereinto a tape T1 (tape width 24 mm), a tape T2 (tape width 18 mm) and a tape T3 (tape width 12 mm) as listed from the larger tape downward.

The tape feed unit 60 is made up of: a feed roller 61 which rotates to feed the processing tape T; a supporting member 62 which supports the feed roller 61 to the apparatus frame 65 (see FIG. 2); a roller bearing portion 63 which rotatably supports the feed roller 61; an embossing feed motor 151 (see FIG. 5) which is capable of rotating the feed roller 61 in normal direction and opposite (reverse) direction of rotation; a power transmitting mechanism (not shown) which transmits the power of the embossing feed motor 151 to the feed roller 61; and a front-end detection sensor 91 which detects the front (or leading) edge of the processing tape T to be fed. When the embossing feed motor 151 is driven, the feed roller 61 is rotated through the power transmission mechanism to thereby feed the processing tape T. At the same time, the front end of the processing tape T being fed is detected by the front-end detection sensor 91. With this detection serving as a trigger, the embossing of Braille characters by the embossing unit 80 is started. [0045] With reference to FIG. 5, a description will now be made about the construction of the control system of the label forming apparatus 1. The label forming apparatus 1 is made up of: an operating section 110 which has the keyboard 3 and the display 4, to thereby govern the user interface such as inputting of the character information and displaying of various information by the user; the ink-character printing section 120 which has the tape cartridge C, the printing head 7 and the printing feed motor 121, to thereby perform ink-character printing on the processing tape T while feeding the processing tape T and the ink ribbon R, based on the inputted character information; the cutting section 140 which has the full cutter 142, the half cuter 144, the full-cutter motor 141 and the half-cutter motor 143, to thereby perform full cutting and half cutting on the printed processing tape T; the Braille-emboss section 150 which has the solenoids 47, the embossing pins 41 and the embossing feed motor 151, to thereby perform embossing on the processing tape T of emboss data based on the printing information while feeding it; a detecting section 170 which has various sensors such as a tape identifying sensor 171, the front-end detection sensor 91, or the like, to thereby perform various detecting operations; a driving section 180 which has a display driver 181, a head driver 182, a printing feed motor driver 183, a cutter motor driver 184, an embossing driver 185, and an embossing feed motor driver 186, to thereby drive various members; and the control section 200 which is connected to each part to thereby perform an overall control of the label forming apparatus 1.

The control section 200 has a CPU 210, a ROM 220, a RAM 230 and an input/output control apparatus (IOC) and is connected to one another by means of an internal bus 260. The CPU 210 inputs various signals and data from each section of the label forming apparatus 1 through the IOC 250. In addition, based on the various inputted signals and data, the various data inside the RAM 230 is processed. Various signal data is outputted to each section inside the label forming apparatus 1 through the IOC 250, to thereby perform the control over the ink-character print processing and Braille-emboss processing.

As a result of this control, various processing can be made to the processing tape T. For example, the processing tape T is subjected to the ink-character printing, the processing tape T is then cut and is thereafter subjected to Braille embossing, whereby a processing tape T can be obtained on which both the ink-character printing and Braille embossing have been made. In addition, it is also possible to subject the tape only to ink-character printing without Braille embossing. It is then cut to thereby obtain a processing (processed) tape T. Furthermore, the processing tape T is cut and then subject it only to Braille embossing. Actually, there is a case in which ink character printing is not performed at all and a case in which printing is made of the insertion direction in the Braille-emboss portion. The processing tape T after having been processed is adhered to an object of adhesion as a complex label containing both ink characters and Braille characters, a label with ink characters, and a label with Braille characters.

With reference to FIGS. 6A and 6B as well as 7A to 7C, a description will now be made about the format of the processing tape T which is subjected to the processing of ink-character printing and Braille embossing. The processing tape T has: an indicating information region (half-cut margin) Th which is constituted by an insertion direction mark (F1) showing the direction of inserting the processing tape T into the Braille-emboss portion, and a top/bottom mark (F2) showing the top-bottom direction of the Braille; and an ink-character/Braille region Tg which is constituted by an ink-character printing region P for printing ink characters, and a Braille-emboss region B for embossing Braille characters. When putting the tape to actual use after having processed it, what is needed by the user is the ink-character/Braille region Tg; the indicating information region Th will no longer be needed any more. Therefore, in order for the user to easily cut off the indicating information region Th, after having processed the tape, and to easily peel off the recording tape Tb and the release tape Te of the processing tape T, the half-cut region Hc is cut by the half cutter 144 to thereby cut only the recording tape Tb of the processing tape T.

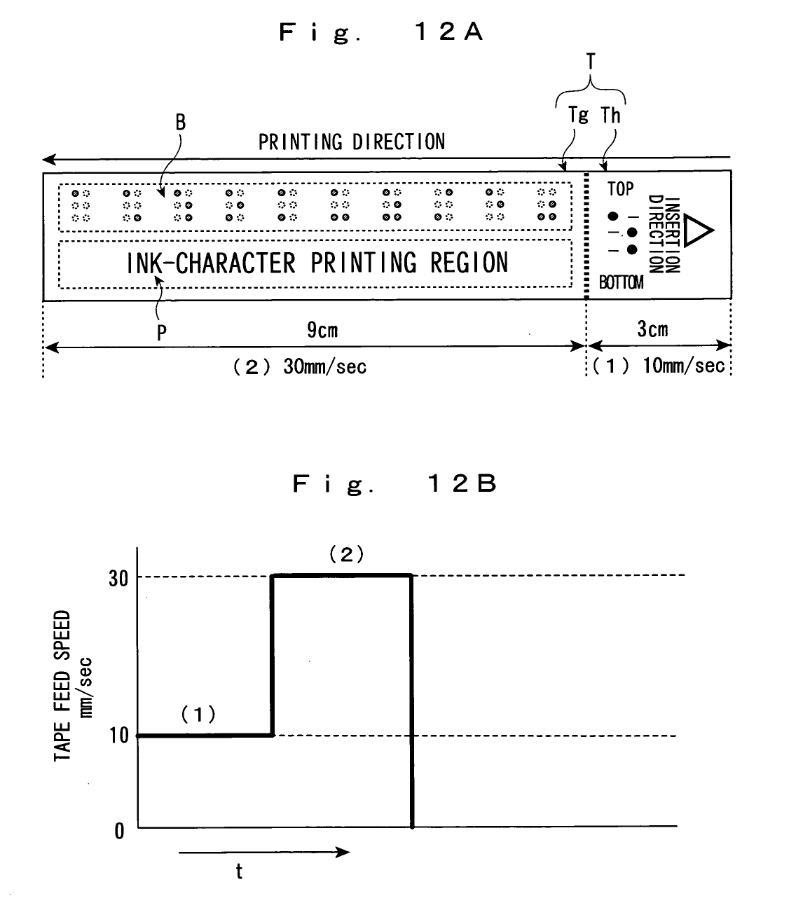

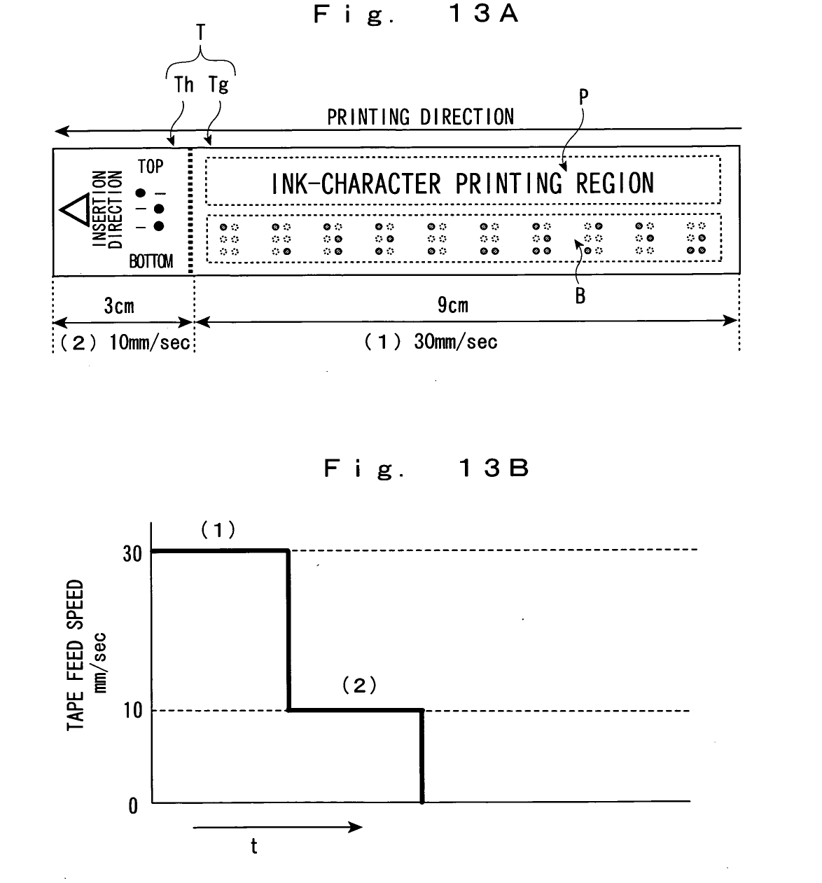

As the Braille format of the processing tape T, there are Braille-upper format (FIG. 12A) and Braille-lower format (FIG. 13A). The Braille-upper format has an ink-character printing region P on the lower side in the ink-character/Braille region Tg, a Braille-emboss region B on the upper side therein, and the indication information region Th on the right side thereof (see FIG. 12A). The Braille-lower format has the ink-character printing region P on the upper side in the ink-character/Braille region Tg, the Braille-emboss region B on the lower side therein, and the indicating information region Th on the left side thereof (see FIG. 13A).

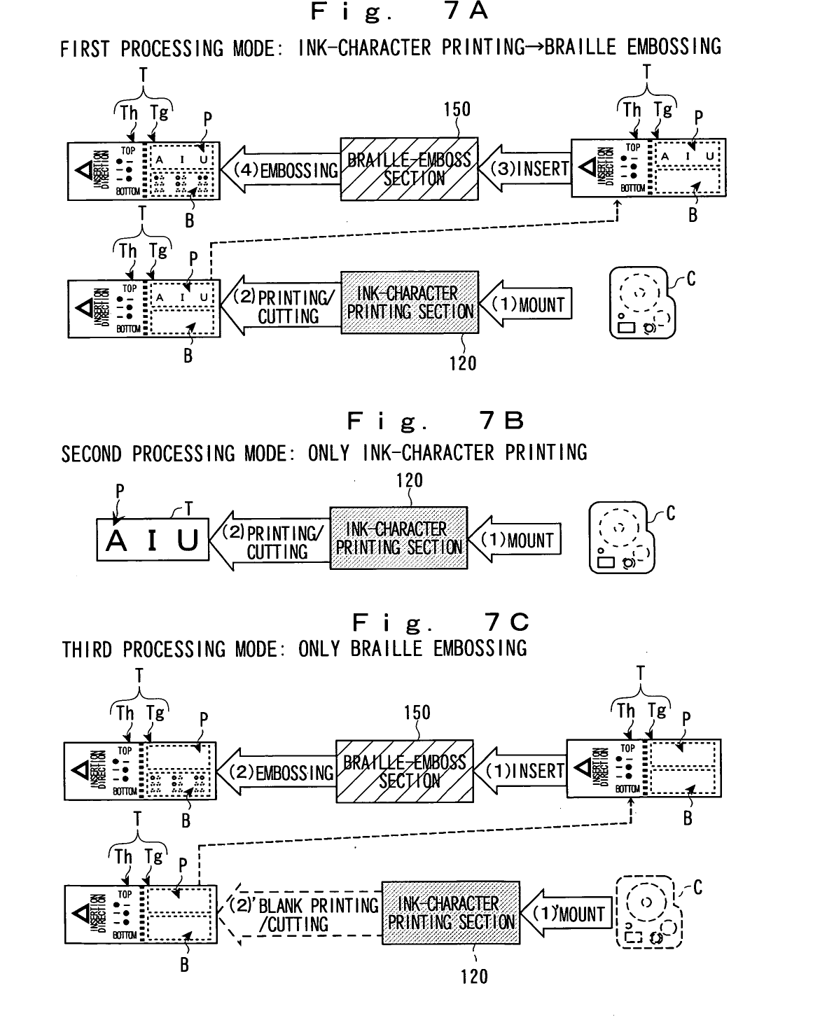

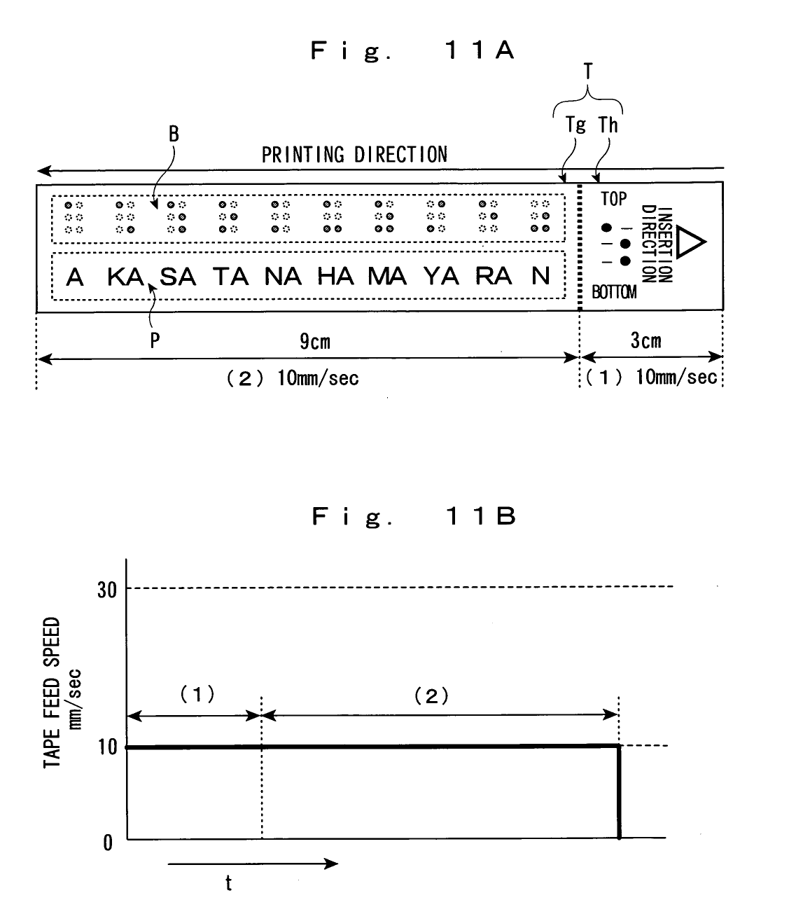

FIGS. 6A and 6B are explanations about the Braille-lower format (FIG. 6A) and the Braille-upper format (FIG. 6B) in inserting the processing tape T into the Braille-emboss section 150. In both the Braille-upper format and the Braille-lower format, after having printed the ink characters P and the indicating information region Th in the ink-character printing section 120, the processing tape T is inserted by the user into the Braille-emboss section 150 according to the arrow in the indicating information region Th (see FIGS. 6A, 6B). It is to be noted that “A,” “I,” “U” are transliteration of Japanese hiragana and that Braille characters represent hiragana, not alphabets. Same applies to other related figures such as FIGS. 7 and 11.

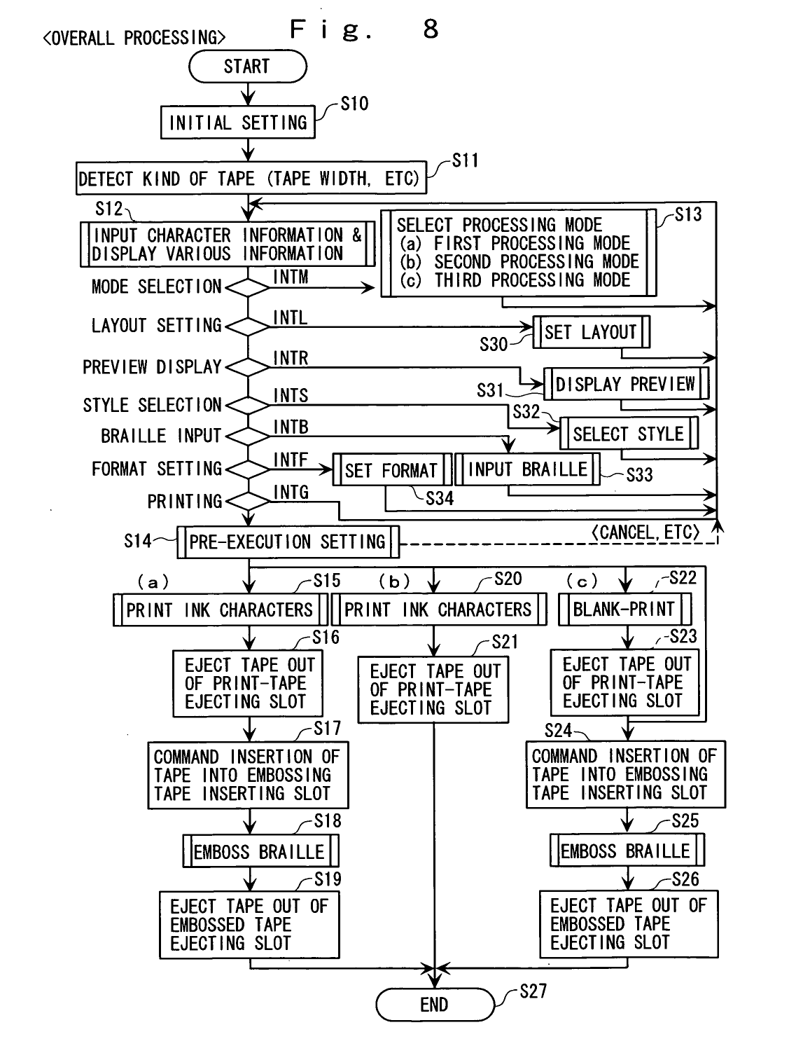

With reference to FIGS. 8 to 11A, 11B, a description will now be made about an overall processing of the label forming apparatus 1. As shown in FIG. 8, when the processing is started by depressing the power switch (switch on), an initial setting is made (S10) by restoring each of the saved control flags to return the state to the one before the previous power off. The kind of the tape is detected by the tape identifying sensor 171 (see FIG. 5) (S11). Subsequently, the character information is inputted by the user by data input through the keyboard 3. Various information is displayed as the editing screen (S12).

Here, an interrupt occurs by the mode selection command (mode key input) from the keyboard 3. When a mode selection interrupt has occurred (INTM), the processing of process mode selection is started up to thereby select one of the first processing mode (complex processing of ink-character printing and Braille embossing), the second processing mode (only ink-character printing), and the third processing mode (only Braille embossing) (S13).

When an interrupt occurs for the layout setting (INTL) by the inputting of the layout setting command (inputting by “layout” key), the processing for the layout setting is started up (S30). When an interrupt occurs for the preview display (INTR) by the inputting of the preview display command (inputting by “preview” key), the processing for the preview display is started up (S31). When an interrupt occurs for the style selection (INTS) by the inputting of the style selection layout (inputting by “style” key), the processing for the style selection is started up (S32).

Further, when an interrupt occurs for the Braille embossing (INTB) by the inputting of the “Braille input” key, the processing for the Braille input is started up (S33). When an interrupt occurs for the format setting (INTF) by the inputting of the format setting command (inputting by “format” key), the processing for the format setting is started up (S34). When an interrupt occurs for the printing (INTG) by the inputting of the printing/execution command (inputting by “print” key), the processing of setting before execution (pre-execution setting) is started up (S14).

At the step of pre-execution setting (S14), final confirmation is made of each setting such as layout plotting, or the like which is required at the time of actual ink-character printing and Braille embossing. In case the interrupt for printing has occurred (INTG) without interrupt for mode setting, interrupt for layout setting, interrupt for preview display, interrupt for style selection, interrupt for Braille inputting, interrupt for format setting, or the like, selection is made, as default, of the previous setting mode (initial setting is first processing mode, Braille-lower, ink-character equal spacing without frame, Braille inputting, without background). Once the pre-execution setting (S14) is finished, actual processing of ink-character printing and Braille embossing is started.

Namely, as shown in FIGS. 8 and 7A to 7C, in the first processing mode (Sl3: (a)), printing is made in the ink-character printing region P and the indicating information region Th by the ink-character printing section 120, and half cutting and full cutting of the processing tape T is made (S15). The processing tape T is then ejected out of the print-tape ejecting slot 22 (S16), and a display is made on the display 4 of the command to insert the tape into the embossing tape inserting slot 31 (S17). This display may alternatively be made by means of a visual device such as LED, LCD or by means of a visual-audio device in sound.

When the processing tape T is inserted by the user (manual insertion) into the embossing tape inserting slot 31 according to the tape insertion command, embossing of Braille characters is performed on the Braille-emboss region B by means of the Braille-emboss section 150 (Braille embossing) (S18). Thereafter, the processed tape T is ejected out of the embossed tape ejecting slot 32 (S19) and the processing is finished (S27).

In the second processing mode (S13: (b)), ink characters are printed by the ink-character printing section 120 (S20) and then the processing tape T is cut and ejected (S21), thereby finishing the processing (S27). In other words, in the second processing mode, as shown in FIG. 7B, printing is made in the ink-character printing region P by feeding the processing tape T paid out of the mounted tape cartridge C into the ink-character printing section 120.

In the third processing mode (S13: (c)), printing is made in the indicating information region Th by the ink-character printing section 120 (S22), and the processing tape T is subjected to half cutting and full cutting (S22). The processing tape T is then ejected out of the print-tape ejecting slot 22 (S23), and a display is made on the display 4 to command the insertion of the processing tape T into the embossing tape inserting slot 31 (S24). This display may alternatively be made by means of a visual device such as LED, LCD or by means of a visual-audio device in sound.

When the processing tape T is inserted by the user (manual insertion) into the embossing tape inserting slot 31 according to the tape insertion command, embossing of Braille characters is performed on the Braille-emboss region B by means of the Braille-emboss section 150 (Braille embossing) (S25). Thereafter, the processed tape T is ejected out of the embossed tape ejecting slot 32 (S26) and the processing is finished (S27).

Although not shown, the following is also possible. Namely, as the specification in which the tape cartridge C can be mounted on the upstream side of the Braille-emboss section 150, Braille embossing is performed on the elongated tape paid out of the tape cartridge C. Further, the ink-character printing and Braille embossing may be performed based not on the same character information but on different character information.

At the step of layout setting (S30), setting similar to that of an ordinary tape printer, a word processor, or the like is made such as the setting of a relative position between the ink-character printing region P and the Braille-emboss region B, length of each layout plotting portions (length of printing portion, length of embossing portion, length of common portion, or the like).

In the first processing mode (complex processing of ink-character printing and Braille embossing) and in the third processing mode (only Braille embossing), selection is made between the Braille-lower format in which the ink-character printing region P is on the upper half, and the Braille-emboss region B is on the lower half (FIGS. 6A, 13A, 13B), and the Braille-upper format in which the ink-character printing region P is on the lower half and the Braille-emboss region B is on the upper half (FIGS. 6B, 12A, 12B).

In the label forming apparatus 1, the above-referenced ink-character array can be directly converted by the Braille input (S33 in FIG. 8) to form information for Braille embossing (Braille information) such as character array for Braille characters (Braille array, Braille-cell array), or the like. It is also possible regarding the Braille array to select a certain style for framing, table forming, or the like by the above-referenced style selection (S32 in FIG. 8). Further, by means of the above-referenced format setting (S34 in FIG. 8), a certain format of background printing, or the like can be selected and set for the Braille portion embossed with Braille characters.

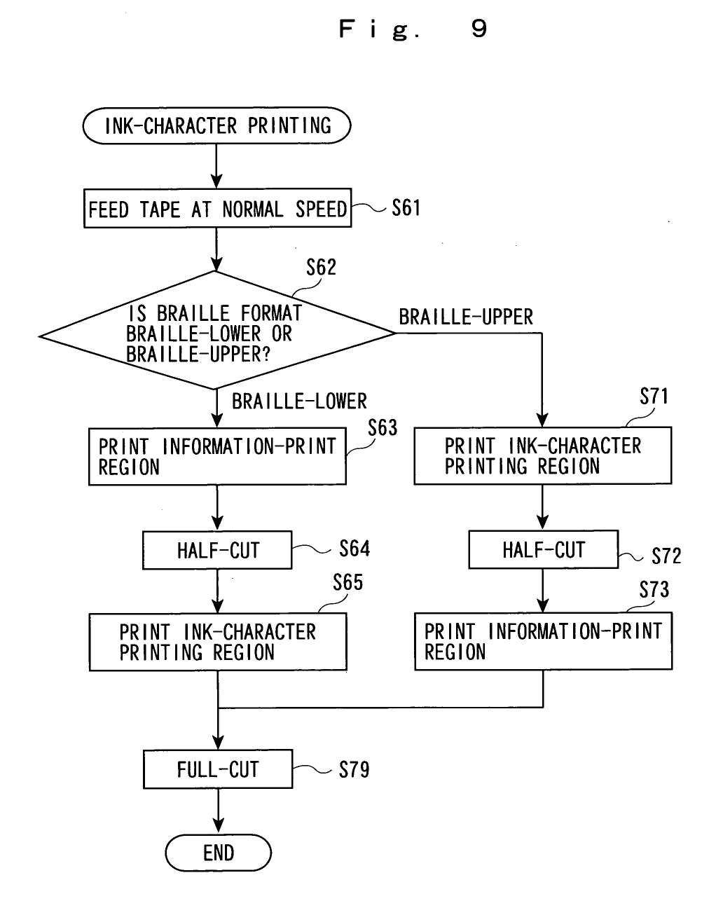

With reference to FIG. 9, a description will now be made about the subroutine of controlling the tape feed speed in the ink-character printing (S15 in FIG. 8) by the ink-character printing section 120 in the first processing mode (S13: (a) in FIG. 8). When the ink-character printing information is made available, the tape feed speed control in the Braille-lower format is made in the following manner. After the processing of the ink-character printing is started, the tape feed speed is set at a normal speed (10 mm/sec) (S61). If the Braille format is judged to be Braille-lower (S62), ink-character printing is made of the Braille-emboss insertion mark and the Braille-top or Braille-bottom mark in the indicating information region Th (S63), and half cutting is made of the recording tape Tb of the processing tape T (S64). Then, the ink-character printing is made of the inputted printing information in the ink-character printing region P (S65), and the processing tape T is subjected to cutting by the full cutter 142 (S79), thereby finishing the processing.

When the ink-character printing information is made available, the tape feed speed control in the Braille-upper format is made in the following manner. After the processing of the ink-character printing is started, the tape feed speed is set at a normal speed (10 mm/sec) (S61) . If the Braille format is judged to be Braille-upper (S62), ink-character printing is made of the inputted printing information in the ink-character printing region P (S71), and half cutting is made of the recording tape Tb of the processing tape T (S72). Then, the ink-character printing is made of the Braille-emboss insertion mark and the Braille-top and Braille-bottom mark in the indicating information region Th (S73), and the processing tape T is subjected to cutting by the full cutter 142 (S79), thereby finishing the processing.

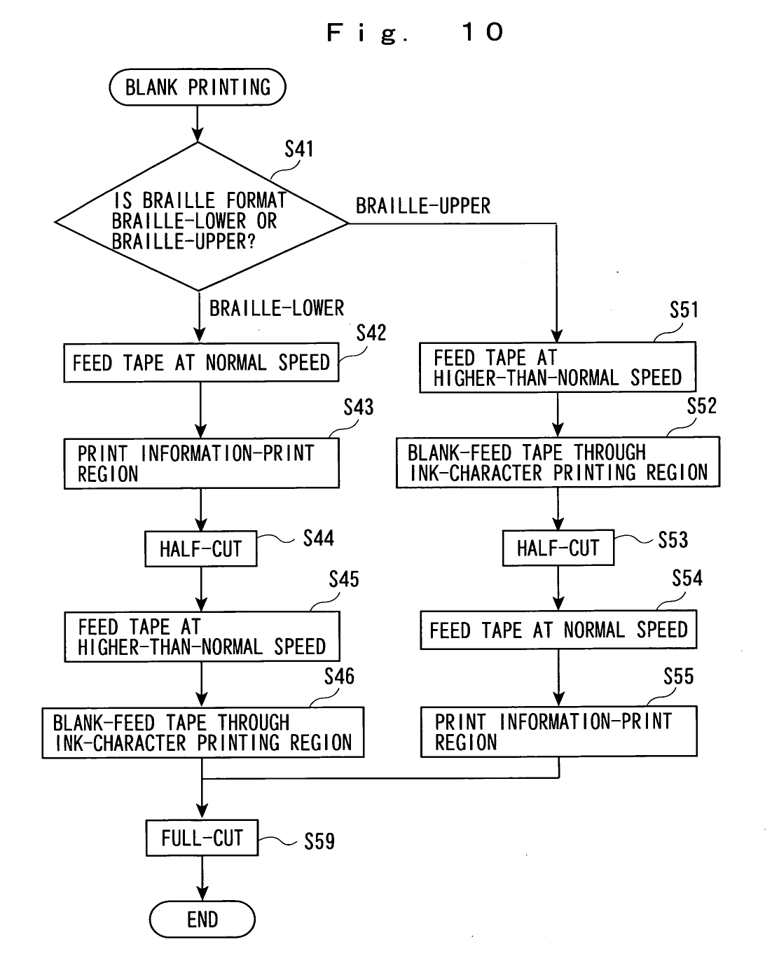

With reference to FIG. 10, a description will now be made about the subroutine of controlling the tape feed speed in the blank printing (S22 in FIG. 8) by the ink-character printing section 120 in the third processing mode (S13: (c) in FIG. 8). When the ink-character printing information is not made available and the Braille format is Braille-lower, the tape feed speed control is made in the following manner. Once the Braille format is judged to be Braille-lower (S41), the tape feed speed is set at a normal speed (10 mm/sec) (S42). Ink-character printing is made of the Braille-emboss insertion mark and the Braille-top or Braille-bottom mark in the indicating information region Th (S43), and half cutting is made of the recording tape Tb of the processing tape T (S44). Then, the tape feed speed is set to one (30 mm/sec) which is higher than that at the time of normal ink-character printing (S45). The processing tape T is fed through the ink-character printing region P while maintaining this high tape feed speed (i.e., the processing tape T is fed “blank” without any printing thereon; also referred to as “blank printing”) (S46). The processing tape T is then subjected to cutting by the full cutter 142 (S59), thereby finishing the processing.

In case there is no ink-character printing information and the Braille format is Braille-upper, the tape feed speed control is made as follows. If the Braille format is judged to be Braille-upper after having started the blank-print processing (S41), the tape feed speed is set to be one (30 mm/sec) which is higher than the normal feed speed at the time of printing (S51), and the ink-character printing region P is fed blank (S52) while maintaining the high tape feed speed. The processing tape T is then subjected to half cutting of the recording tape Tb (S53) . Then, the normal tape feed speed (10 mm/sec) is set (S54), and the Braille-emboss insertion mark and the Braille-top and Braille-bottom mark are printed in the indicating information region Th (S55) . The processing tape T is then cut by the full cutter (S59), thereby finishing the processing.

With reference to FIGS. 11A, 11B, 12A, 12B, 13A and 13B, a description will now be made about the tape feed speed using concrete figures. The ink-character /Braille region Tg has Braille characters “A, KA, SA, TA, NA, HA, MA, YA, RA, N.” Suppose that the processing tape T has an indicating information region Th of 3 cm long and an ink-character/Braille region Tg of 9 cm long, a total of 12 cm long. The tape feed speed is 10 mm/sec at the time of printing the ink characters, and the tape feed speed at the time of blank feeding (“to feed the tape blank”) without performing ink-character printing at the ink-character printing section 120 is 30 mm/sec which is higher than the normal tape feed speed at the time of ink-character printing.

With reference to FIGS. 11A and 11B, a description will be made about the tape feed speed in the first processing mode (complex processing of ink-character printing and Braille embossing). The tape feed speeds of the indicating information region Th and the ink-character/Braille region Tg are respectively set to be 10 mm/sec. The processing time of the processing tape T is 3 seconds with the indicating information region Th (FIG. 11A(1)) and 9 second with the ink-character/Braille region Tg (FIG. 11A(2)), a total processing time of 12 seconds for processing the tape (see FIGS. 11A and 11B). This required time for the tape processing is the same as that with the conventional tape feed method.

With reference to FIGS. 12A and 12B, a description will now be made about the tape feed speed of the third processing mode (only Braille embossing) in which the Braille format is Braille-upper. The tape feed speed of the indicating information region Th is set to be 10 mm/sec, and that of ink-character/Braille region Tg is set to be 30 mm/sec. According to this configuration, the processing time of the processing tape T is 3 seconds with the indicating information region Th (FIG. 12A(1)) and 3 seconds with the ink-character/Braille region Tg (FIG. 12A(2)), resulting in a total process time of 6 seconds (see FIGS. 12A and 12B). In case the indicating information region Th is not set, the tape feed speed is set to be 30 mm/sec over the entire length.

With reference to FIGS. 13A and 13B, a description will now be made about the third processing mode (only Braille embossing) in which the Braille format is Braille-lower. The tape feed speed of the ink-character /Braille region Tg is set to be 30 mm/sec, and that of the indicating information region Th is set to be 10 mm/sec. According to this configuration, the processing time of the processing tape T is 3 seconds with the ink-character/Braille region Tg (FIG. 13A(1)) and 3 seconds with the indicating information region Th (FIG. 13B(2)), resulting in a total process time of 6 seconds (see FIGS. 13A and 13B). The tape feed speed in Braille embossing shall preferably be controlled such that the speed at which the non-embossing region (not shown) of the processing tape T passes through the embossing unit 80 is 25 mm/sec and that the speed at which the embossing region (not shown) passes through the embossing unit 80 is 15 mm/sec.

As described hereinabove, according to the method of controlling tape feed in the Braille-emboss apparatus of this embodiment, the tape feed speed at the time when the Braille-emboss region of the processing tape passes through the ink-character printing device during Braille-emboss processing is controlled to be higher than the tape feed speed at the time of ink-character printing. Therefore, the time required for the entire tape processing can be shortened, whereby the time efficiency of tape processing can be improved.

It is further understood by those skilled in the art that the foregoing is the preferred embodiment of the invention, and that various changes and modifications may be made without departing from the spirit and scope thereof.

What is claimed is:

1. A tape processing apparatus comprising:
a feeding device for feeding a processing tape along a tape feed passage;
an ink-character printing device for printing ink characters and a Braille-emboss device for embossing Braille characters, respectively on the processing tape to be fed by the feeding device;
a mode selecting device for selecting one of an ink-character print processing, a Braille-emboss processing, and a complex processing of ink-character printing and Braille embossing; and
a feed control device for controlling the feeding device,
wherein the feed control device controls, in the Braille-emboss processing, such that a tape feed speed when a Braille-emboss region of the processing tape passes through the ink-character printing device is higher than a tape feed speed at a time of printing.

2. The apparatus according to claim 1,
wherein, in the Braille-emboss processing, an information-print region for printing therein indicating information which indicates a manual insertion direction is set on an outside of a Braille-emboss region,
wherein the processing tape is manually inserted into the Braille-emboss device after having printed the indicating information by the ink-character printing device, and
wherein the feed control device controls, in the Braille-emboss processing, such that the tape feed speed when the information-print region passes through the ink- character printing device is equal to the tape feed speed at the time of printing.

3. A feed control method of a tape processing apparatus, the apparatus comprising a feeding device for feeding a processing tape along a tape feed passage, and an ink-character printing device for printing ink characters and a Braille-emboss device for embossing Braille characters, respectively on the processing tape to be fed by the feeding device, the apparatus selectively performing one of an ink-character print processing, a Braille-emboss processing and a complex processing of ink-character printing and Braille embossing,
wherein the method comprises controlling, in the Braille-emboss processing, such that the tape feed speed when a Braille-emboss region of the processing tape passes through the ink-character printing device is higher than a tape feed speed at a time of printing.

4. A feed control method of a tape processing apparatus according to claim 3, wherein, in the Braille-emboss processing, an information-print region for printing therein indicating information which indicates a manual insertion direction is set on an outside of a Braille-emboss region,
wherein the processing tape is manually inserted into the Braille-emboss device after having printed the indicating information by the ink-character printing device, and
wherein the feed control device controls, in the Braille-emboss processing, such that the tape feed speed when the information-print region passes through the ink- character printing device is equal to the tape feed speed at the time of printing.

5. A program for causing a computer to operate each of the devices in the tape processing apparatus according to claim 1.
